(19) United States
(12) Patent Application Publication
(10) Pub. No.: US 2025/0246027 A1
(43) Pub. Date: Jul. 31, 2025

(54) SYSTEM AND METHOD FOR VEHICLE TOLL MANAGEMENT

(71) Applicant: ACCENTURE GLOBAL SOLUTIONS LIMITED, Dublin 4 (IE)

(72) Inventors: Ricardo André SANTOS GOMES DE ALMEIDA, Lisboa (PT); Sidney EDMONDS, Austin, TX (US); Ana Mafalda Cardoso da Costa Magalhaes Colaco, Algés (PT)

(73) Assignee: ACCENTURE GLOBAL SOLUTIONS LIMITED, Dublin 4 (IE)

(21) Appl. No.: 19/036,861

(22) Filed: Jan. 24, 2025

Related U.S. Application Data
(60) Provisional application No. 63/625,866, filed on Jan. 26, 2024.

(51) Int. Cl. G07B 15/06; G06V 10/764; G06V 10/94; G06V 20/54; G06V 20/62; H04W 4/021; H04W 4/80

(52) U.S. Cl. CPC G07B 15/06; G06V 10/764; G06V 10/95; G06V 20/54; G06V 20/625; H04W 4/021; H04W 4/80; G06V 2201/08

(57) ABSTRACT

System and method for vehicle toll management are disclosed herein. For example, toll records of toll gates along a roadway are accessed. The toll records include sensor data including data associated with Radio Frequency Identifier (RFID) tags and image data. Further, it is determined, from the toll records of a first toll gate, that a vehicle is passed without paying toll. Furthermore, the vehicle is determined via processing of the image data associated with the first toll gate and/or a subset of the toll gates. Also, a correlation process that automatically correlates the toll records to mobile communication network data of base stations proximate to the first toll gate and/or the subset toll gates is executed. Based on the correlation, identification information of a mobile device corresponding to a user of the vehicle is then determined. A notification is then transmitted to the mobile device regarding payment of the toll.

### TECHNICAL FIELD

Various examples described herein relate generally to a system and method for vehicle toll management. Specifically, disclosed examples are directed to the system and a method for providing toll analytics and services to identify vehicles travelled through toll gates and support tolling.

### BACKGROUND

Many road infrastructure systems (i.e., roads, bridges, tunnels, etc.) utilize toll gates or toll gates to manage flow of traffic and funds for infrastructure construction and maintenance of a roadway. For example, the toll gates may be deployed to capture toll records including information regarding vehicles travelling along the roadway. The captured information may be used to pay costs associated with construction and/or maintenance of the roadway. Existing toll gates may utilize sensors (e.g., radio frequency (RF) communication tags, cameras, and the like) to capture information from the vehicles driving along the roadway. The toll gates may transmit the information captured by the sensors to a central system over a network communication link to facilitate billing and payment of tolls charged for use of the roadway(s) subject to tolling.

Generally, toll systems enable owners and drivers of the vehicles to register their vehicles with a service provider that manages a toll system and become registered users. The registered users may receive a toll tag, which is typically a radio frequency (RF) device that is placed on a windshield or another location of the vehicles. The toll tag may be scanned by the sensors of each toll gate the vehicle passes through to track which toll gates the vehicle travelled through. In addition to reading the RF tag, the sensors may use a camera to capture license plate information and an image of the vehicle. The central system may then use the information regarding which toll gates the vehicle travelled through to calculate charges for use of the toll system, which may be based on stretches of road (e.g., as determined between two consecutive toll gates) travelled by the vehicle.

### SUMMARY

While the ability to register vehicles enables identification of some users of toll systems, many vehicles travelling on the toll systems are not registered and therefore, may not have a toll tag that may be scanned or a license plate known by the toll systems. In such instances, a central system may use information captured by image sensors (e.g., cameras) of each toll gate to identify the vehicle. For example, an image of a license plate of each vehicle passing through a toll gate may be captured by the cameras and the license plate detected within that image may then be used to try to identify the vehicle owner, such as by accessing a department of motor vehicles database to determine the owner of the vehicle having ownership of the vehicle. However, the image may be unreadable due to weather conditions, damage, or the driver may have used a variety of techniques to prevent detection of the license plate information using the cameras (e.g., covering it up, removing the license plate, etc.). In such instances, it may be impossible for the toll system to determine who should be charged for use of the roadway.

Further, in some instances, identification of a vehicle owner may be achieved, such as based on the license plate and consultation with a department of motor vehicles database, however, the information provided may be outdated, leading to inconsistencies in vehicle owner details. For example, the address of the vehicle owner may be incorrect. In such instances, the bill may be sent to a correct person or company, but at wrong address, resulting in the bill never being received and therefore, going unpaid. As another example, the sensors may capture a blurry image of the license plate, which cannot be used to identify the vehicle license plate, the vehicle owner and send the bill to the owner at a physical address.

In an aspect, the present disclosure relates to a system including at least one hardware processor and at least one non-transitory processor-readable medium storing instructions to be executed by the at least one hardware processor to access toll records of a plurality of toll gates along a roadway, the toll records include sensor data from Radio Frequency Identifier (RFID) sensors and image sensors installed at the plurality of toll gates, wherein the sensor data includes data associated with RFID tags from the RFID sensors and image data from the image sensors, determine from the toll records of a first toll gate of the plurality of toll gates, that a vehicle passed through the first toll gate without paying toll, process the image data from the image sensors installed at one or more of the first toll gate and at least a subset of the plurality of toll gates via automatic image recognition techniques, identify the vehicle via the processing of the image data, automatically execute a correlation process that correlates the toll records pertaining to the vehicle to mobile communication network data of base stations proximate to one or more of the first toll gate and at least the subset of the plurality of toll gates, determine, based on the correlation, identification information of a mobile device corresponding to a user of the vehicle, and transmit a notification to the mobile device regarding payment of the toll based at least on the identification information.

In some examples, the instructions to identify the vehicle from the image data further cause the at least one hardware processor to classify the toll records into three categories including a first category of toll records of registered vehicles with RFID tags that are successfully scanned or toll records of registered vehicles with license plates successfully identified from the image sensors, a second category of toll records of unregistered vehicles with license plates successfully identified from the image sensors of the first toll gate and a third category with toll records of unidentified vehicles including vehicles with unidentified license plates from the image data.

In some examples, the instructions to identify the vehicle from the image data further cause the at least one hardware processor to identify the vehicle from the image data captured by the image sensors of the first toll gate and at least the subset of the plurality of toll gates that include a preceding toll gate and a succeeding toll gate of the first toll gate.

In an example implementation, the instructions to identify the vehicle from the image data further cause the at least one hardware processor to identify a license plate of the vehicle from the image data, and determine that a license plate number of the vehicle is unidentifiable from the image data.

In an aspect, the instructions to execute the correlation process automatically correlating the toll records pertaining to the vehicle to the mobile communication network data further cause the at least one hardware processor to execute an event-based matching technique that includes temporal alignment, sequence similarity and event context matching of events emitted by the sensors of the first toll gate and at least the subset of the plurality of toll gates and events fired by the base stations proximate to the first toll gate and at least the subset of the plurality of toll gates, calculate a similarity score via the execution of the event-based matching technique, and identify a subset of the events fired by the base stations for the mobile device corresponding to the vehicle based on the similarity score.

In some examples, the instructions to execute the temporal alignment further cause the at least one hardware processor to calculate the temporal overlap of the events associated with the vehicle from the first toll gate, at least the subset of the plurality of toll gates and the base stations based on a sequence of event timestamps.

In an example, the instructions to obtain the sequence similarity further cause the at least one hardware processor to align and compare sequence of the events associated with the vehicle from the first toll gate, at least the subset of plurality of toll gates and the base stations.

In an example implementation, the instructions to align and compare the sequence of events associated with the vehicle further cause the at least one hardware processor to implement dynamic time wrapping (DTW), wherein the sequence of events are ordered and compared as time series data, compare the ordered time series data via a longest common subsequence (LCS) process and match event contexts via extracting and comparing temporal metadata from the first toll gate, at least the subset of the plurality of toll gates and the base stations.

In another example implementation, the instructions to execute the correlation process of automatically correlating the toll records pertaining to the vehicle to the mobile communication network data further cause the at least one hardware processor to pre-process event data of events fired by the sensors of the first toll gate and at least the subset of the plurality of toll gates and events from the mobile network data fired by the base stations proximate to the first toll gate and at least the subset of the plurality of toll gates, wherein pre-processing the event data includes normalizing locations and mapping corresponding events fired at same location by the sensors and the base stations.

In some examples, the instructions to pre-process the event data further cause the at least one hardware processor to filter invalid and outlier data, and impute missing data from available dataset of the events.

For example, the instructions to execute the correlation process further cause the at least one hardware processor to extract spatial and temporal features of the events emitted by the sensors of the first toll gate and the subset of toll gates and events fired by the base stations proximate to the first toll gate and at least the subset of the plurality of toll gates.

In an example implementation, the instructions to calculate the similarity score further cause the at least one hardware processor to calculate the similarity score using a composite scoring mechanism that weighs spatial, temporal and event similarity.

In another aspect, the present disclosure relates to a method including accessing, by a processor, toll records of a plurality of toll gates along a roadway, the toll records include sensor data from Radio Frequency Identifier (RFID) sensors and image sensors installed at the plurality of toll gates. For example, the sensor data may include data associated with RFID tags from the RFID sensors and image data from the image sensors. Further, the method includes determining, by the processor, from the toll records of a first toll gate of the plurality of toll gates, that a vehicle passed through the first toll gate without paying toll. Furthermore, the method includes processing, by the processor, the image data of from the image sensors installed at one or more of the first toll gate and at least a subset of the plurality of toll gates via automatic image recognition techniques.

In addition, the method includes identifying, by the processor, the vehicle via the processing of the image data. Moreover, the method includes executing, by the processor, a correlation process that automatically correlates the toll records pertaining to the vehicle to mobile communication network data of base stations proximate to one or more of the first toll gate and at least the subset of the plurality of toll gates. Also, the method includes determining, by the processor, based on the correlation, identification information of a mobile device corresponding to a user of the vehicle. Further, the method includes transmitting, by the processor, a notification to the mobile device regarding payment of the toll based at least on the identification information.

In yet another aspect, the present disclosure relates to a non-transitory processor-readable storage medium including machine-readable instructions that may be executable by a processor to perform the method as discussed herein.

It is appreciated that method in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features of the present disclosure will be apparent from the description and drawings, and from the claims.

### BRIEF DESCRIPTION OF THE FIGURES

Various implementations in accordance with the present disclosure will be described with reference to the drawings, in which:

FIG. 1 depicts a block diagram illustrating an example environment that may be used to execute implementations of the present disclosure.

FIG. 2 depicts a block diagram illustrating exemplary use cases for providing analytics and services, in accordance with implementations of the present disclosure.

FIG. 3 is a flow diagram that presents a method for vehicle toll management, in accordance with implementations of the present disclosure.

FIG. 4 depicts an example computer system that may be used to carry out the method described in FIG. 3, in accordance with implementations of the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to;” it specifically indicates open-ended inclusion or membership in the so-described combination, group, series, and the like.

The term “a” means “one or more” unless the context clearly indicates a single element.

“First,” “second,” and/or the like, are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, and/or the like).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the disclosure as set forth in the claims.

Implementations of the present disclosure provide functionality to identify vehicles travelling in a toll system. In an aspect, analytics provided in accordance with the present disclosure may be used to classify vehicles travelling within the toll system according to vehicle features to produce sets of toll records in which similar vehicles are grouped together. For example, the disclosed analytics may use image processing techniques to group sensor data (e.g., image data captured by image sensors of toll gates) into different classifications or categories based on features of vehicles. The classification of the toll records may produce smaller sets of data in which toll records associated with the similar vehicles are created. The smaller categories of toll records may then be analyzed using a variety of analytics to identify portions of the toll records corresponding to specific vehicles (e.g., toll records A, B, and C correspond to vehicle 1, toll records D, E, F correspond to vehicle 2, and the like.).

The analytics provided in accordance with the present disclosure may utilize toll data included in toll records and mobile communication network data obtained from base stations via a communication network to determine correlations between vehicles traveling past a specific toll gate and a telecommunications base station near a location of the toll gate. For example, if a set of data records includes timestamp information indicating a set of vehicles travelling past a set of toll gates and the communication data indicates mobile devices connected to base stations proximate to the toll gate locations, the analytics may be configured to determine specific mobile devices connected to the base stations proximate to the toll gate at times corresponding to sensor data capture times, which may indicate specific mobile devices correspond to the vehicles associated with the toll records including the sensor data. The disclosed analytics may also utilize additional types of data to determine correlations between the toll data records, such as financial transaction data, rental car data records, or other types of data from various data sources.

Once a set of toll records are associated with a specific vehicle, the disclosed techniques may determine whether any of the toll records are associated with a known registered user with the toll system or with vehicle owner. While the vehicle is driven through the toll system, the sensor data may not enable identification of the vehicle. For example, for registered users with a Radio Frequency (RF) tag, the RF tag may not be read, because of low battery, incorrect placement in the vehicle or toll sensor malfunction. In this case, the toll system may try to capture image data of the vehicle license plate. Capturing the image data of the vehicle license plate is typically applicable to all the situations where the RF tag is not read such as in the previous example, for registered users with license plate based accounts and for unregistered vehicles. However, the license plate information captured by image sensors (e.g., sensors with a camera) of the toll gate may be incomplete, unreadable, or missing due to weather or other reasons, such as a faulty or damaged camera. Thus, some toll transactions may not be properly associated to the respective registered user account in the toll system or to the vehicle owner. However, using the analytics described herein, the sensor data that does not enable identification or association of the vehicle to the registered user or the vehicle owner may be analyzed based on data from other data sources (e.g., mobile communication network data from the base stations, financial transaction data obtained from a financial service provider, and the like) to associate the sensor data with a specific registered user or vehicle owner. In such instances, the disclosed systems and methods may enable the association of the toll transactions with the respective registered user account in the toll system or the identification of the vehicle owner and the transmission of a notification to the driver that includes information for facilitating payment for toll transactions.

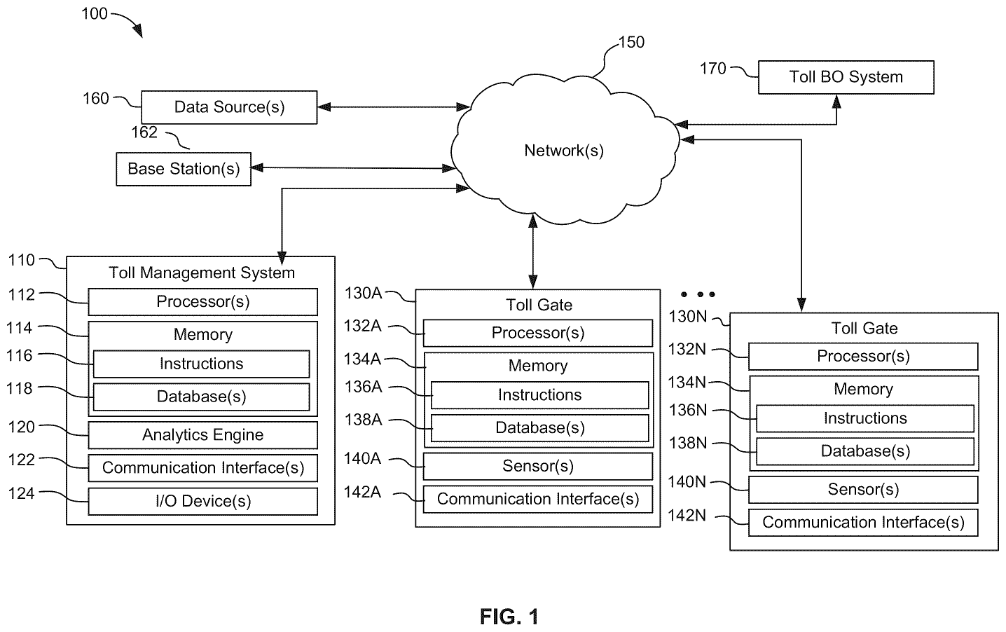

FIG. 1 depicts an example environment 100 that may be used to execute implementations of the present disclosure. In some examples, the example environment 100 performs vehicle toll management including providing toll analytics and services. As depicted in FIG. 1, the example environment 100 includes a toll management system 110, a plurality of toll gates 130A-130N, base station(s) 162, data source(s) 160 and a toll back office (BO) system communicatively coupled to each other via a communication network(s) 150.

As shown in FIG. 1, the toll management system 110 includes one or more processors 112, a memory 114, an analytics engine 120, one or more communication interfaces 122, and one or more input/output (I/O) devices 124. Examples of the processor 112 may include but are not limited to, microprocessors, microcomputers, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. The processor 112 may be communicatively coupled with the memory 114. Further, the processor 112 may be configured to execute instructions 116 (also referenced herein as processor-executable instructions) for performing operations according to the present disclosure.

In some examples, the memory 114 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the toll management system 110 may be stored in the memory 114 as the instructions 116 that, when executed by the one or more processors 112, cause the one or more processors 112 to perform the operations described herein with respect to the toll management system 110, as described in more detail below. The memory 114 may be non-volatile or non-transitory processor-readable storage medium, such as a magnetic disk or solid-state non-volatile memory or volatile medium such as Random Access Memory (RAM), and/or the like. Additionally, the memory 114 may be configured to store one or more databases 118. Exemplary aspects of the one or more databases 118 are described in more detail below.

Further, the one or more communication interfaces 122 may be configured to communicatively couple the toll management system 110 to a toll back-office system 170 and to the toll gates 130A-N via the network 150. For example, the network 150 uses wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, and an IEEE 802.16 protocol, a 3rd Generation (3G) communication standard, a 4th Generation (4G)/long term evolution (LTE) communication standard, a 5th Generation (5G) communication standard, and the like). The one or more input/output I/O devices 124 may include one or more display devices, a keyboard, a stylus, one or more touchscreens, a mouse, a trackpad, a camera, one or more speakers, haptic feedback devices, or other types of devices that enable a user to receive information from or provide information to the toll management system 110.

Also, as shown in FIG. 1, each of the toll gates 130A-130N includes multiple components. For example, a first toll gate (e.g., the toll gate 130A) may include one or more processors 132A, a memory 134A, one or more sensors 140A, and one or more communication interfaces 142A. The one or more processors 132A may be similar to the one or more processors 112. The memory 134A may store instructions 136A that, when executed by the one or more processors 132A, cause the one or more processors 132A to perform operations for capturing information associated with vehicles passing by the toll gate 130A using the one or more sensors 140A. For example, when a vehicle passes the toll gate 130A, the sensors 140A may capture information such as the vehicle's license plate, make, model and color. The sensors 140A can also measure the vehicle's physical characteristics including height, length and number of axles, allowing the processors 132A to determine the vehicle's classification. Additionally, the sensors 140A can read information from a RF tag that may be installed in the vehicle. The one or more sensors 140A may include RFID sensors (e.g., RF tag readers), image sensors with cameras, or other types of sensors configured to capture information from vehicles passing through the toll gate 130A. The communication interface(s) 142A may be configured to support wired or wireless communication between the toll gate 130A and one or more remote devices, such as the toll management system 110, the toll back-office system 170, and the like.

Further, the data sources 160 may include public or private data stores containing information that may be utilized by the toll management system 110 to provide analytics and services to support operation and management of the toll back-office system 170. For example, the data sources 160 may include one or more databases maintained by a department of motor vehicles containing records associated with vehicle and vehicle owner information, one or more databases containing cell phone records for a cellular communications network (e.g., records containing information associated of cell phone towers one or more mobile devices have connected to, timestamp data, or other types of information), or other types of data sources. User data such as, aesthetic preferences of the user (e.g., the driver or vehicle owner) may be collected, used, stored and deleted only based on an explicit consent received from the user and applicable regulations. Therefore, implementations of the present disclosure operate only on the small slice of data that the user has consented to, and do not operate on a full brain scan worth of data. The ethical considerations may indicate one or more of laws, rules, and regulations applicable for vehicle toll management.

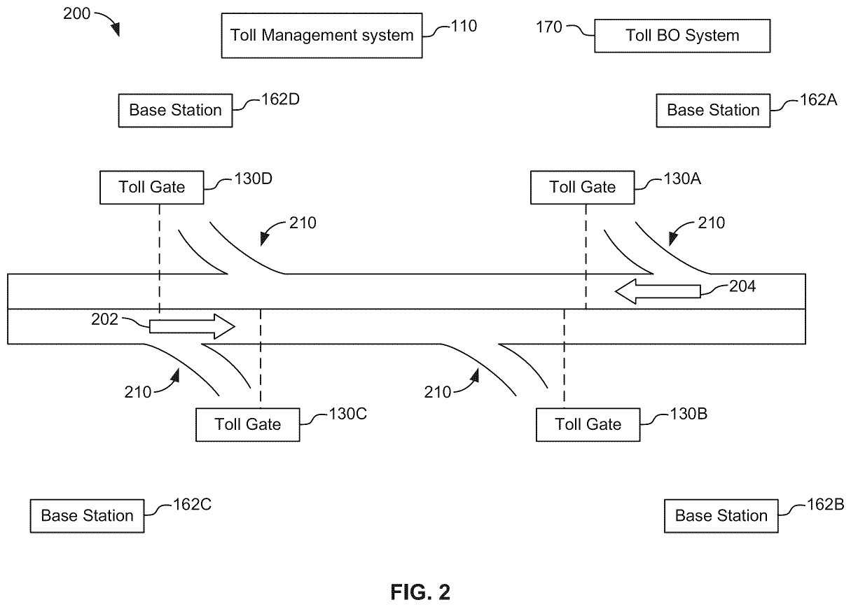

Furthermore, the analytics engine 120 may be configured to perform various processes to provide various analytics and services to support administration, management, and operation of a toll back-office system 170 corresponding to the toll gates 130. For example, the analytics provided by the analytics engine 120 may be utilized to identify users of a vehicle (e.g., driver of the vehicle) present at one or more of the toll gates 130A-N based on correlations between toll records (e.g., data captured by the sensors 140A-140N) and data obtained from one or more data sources 160. In an aspect, the one or more data sources 160 may additionally include information associated with or captured by the one or more base stations 162. For example, the one or more base stations 162 may correspond to base stations of a cellular communications network and the analytics engine 120 may use information captured by the one or more base stations 162 to identify drivers passing through one or more of the toll gates 130. Exemplary details regarding identification of drivers using data obtained from a cellular network are described in more detail below and with reference to FIG. 2.

In addition to providing analytics to identify drivers and other types of information in accordance with the concepts described herein, the toll management system 110 may also be configured to provide services to support the toll operation managed by the toll back-office system 170. For example, when the vehicle is identified as having passed through a sequence of toll gates 130 for which a toll is to be billed, the toll management system 110 may transmit a notification to a mobile device of the identified vehicle driver or vehicle owner, where the notification includes billing information for the use of the toll back-office system 170. The notification may include the toll amount being charged for use of the toll back-office system 170, payment information (e.g., a link to a website where payment may be submitted, a link to access an application on the user's mobile device to make payment, an address where payment may be mailed, and the like), date and time information (e.g., information regarding the date and time the driver passed through the one or more toll gates 130), toll gate information (e.g., information regarding the portions of the roadway and/or toll gates passed by the driver), other types of information, or a combination thereof. In an aspect, the notification may also present address information, such as address information obtained from one of the one or more data sources 160 (e.g., a department of motor vehicles database), and request the user confirm the address information is correct. If the information is incorrect, the notification may include one or more mechanisms for updating the user's address information at the relevant data source(s) 160. For example, using the founded user's mobile phone, a notification may be transmitted with a link to a portal where the user may validate and/or update their information.

In an example implementation, the analytics engine 120 may access the toll records of the toll gates 130A-130N along a roadway, the toll records include the sensor data from RFID sensors and image sensors installed at the toll gates 130A-130N. For example, the sensor data may include data associated with RFID tags from the RFID sensors and image data from the image sensors. In an aspect, a particular data record of the toll records includes in addition to the sensor data, location data corresponding to a location of a toll gate generating the data record and time data corresponding to a time of capture of the data record by one or more of the sensors of the toll gate.

Further, the analytics engine 120 may determine from the toll records of the first toll gate 130A that the vehicle passed through the first toll gate 130A without paying toll. Furthermore, the analytics engine 120 may process the image data of from the image sensors installed at one or more of the first toll gate 130A and at least a subset of remaining toll gates 130B-N via automatic image recognition techniques.

In addition, the analytics engine 120 may identify the vehicle via the processing of the image data. In an example implementation, to identify the vehicle via the processing of the image data, the analytics engine 120 may analyze the images data from the image sensors installed at the first toll gate 130A and at least the subset of the toll gates 130B-130N that include toll gates preceding and succeeding the first toll gate 130A along the roadway. Further, the analytics engine 120 may identify passage of the vehicle through the first toll gate 130A and the subset of toll gates 130B-130N from the image analysis.

In another implementation, to identify the vehicle from the image data, the analytics engine 120 may identify a license plate of the vehicle from the image data. Further, the analytics engine 120 may determine that a license plate number of the vehicle is unidentifiable from the image data.

In some examples, to identify the vehicle from the image data, the analytics engine 120 may classify the toll records into three categories including a first category of toll records of registered vehicles with RFID tags that are successfully scanned or with license plates successfully identified from the image sensors that are associated to registered user accounts in the toll system, a second category of toll records of unregistered vehicles with license plates successfully identified from the image sensors of the first toll gate which the toll system cannot associate to any of its registered accounts and a third category with toll records of unidentified vehicles, i.e., vehicles with unidentified license plates from its image data.

Also, the analytics engine 120 may execute a correlation process that automatically correlates the toll records pertaining to the vehicle to the mobile communication network data of the base stations 162 proximate to one or more of the first toll gate 130A and at least the subset of the toll gates 130B-130N. For example, the mobile communication network data may include mobile device information generated by one or more of the base stations 162, the mobile device information may include timestamp data, mobile device identification data, and location data of the base stations.

In an example implementation, to execute the correlation process, the analytics engine 120 may execute an event-based matching technique that includes temporal alignment, sequence similarity and event context matching of events emitted by the sensors 140A of the first toll gate 130A and at least the subset of the toll gates 130B-130N and events fired by the base stations 162 proximate to the first toll gate 130A and at least the subset of the toll gates 130B-130N. For example, the events fired by the sensors 140A may include toll transactions consisting of RFID transponder readings (TAG ID), license plate images, timestamp, toll gate identification, measured vehicle class, lane identification, and the like. Further the events fired by the base stations 162 may include international mobile subscriber identity (IMSI), check-in timestamp, checkout timestamp, base station identification, and the like.

In some examples, temporal overlap of the events associated with the vehicle is calculated from the first toll gate 130A, at least the subset of the toll gates 130B-130N and the base stations 162 based on a sequence of event timestamps. In an aspect, the overlap or proximity of the events are calculated in time, based on time difference between the events or the sequence of event timestamps. For example, two events are likely the same if they appear in the same location during overlapping time windows.

To obtain the sequence similarity, the analytics engine 120 may align and compare sequence of the events associated with the vehicle from the first toll gate 130A, at least the subset of the toll gates 130B-130N and the base stations 162. In this example implementation, dynamic time wrapping (DTW) is implemented. In the DTW, the sequence of events may be ordered and compared as time series data. Further, the ordered time series data may be compared via a longest common subsequence (LCS) process. Furthermore, event contexts are matched via extracting and comparing temporal metadata from the first toll gate 130A, at least the subset of the toll gates 130B-130N and the base stations 162.

In some examples, to execute the correlation process, the analytics engine 120 may pre-process event data of the events fired by the sensors 140A of the first toll gate 130A and at least the subset of the toll gates 130B-130N and the events from the mobile network data fired by the base stations 162 proximate to the first toll gate 130A and at least the subset of the toll gates 130B-130N. Pre-processing the event data may include normalizing locations to create a relation for the same locations from both toll gate 130A and the base stations 162, correlate the tolls gates and base stations that cover the same locations and mapping corresponding events fired at same location by the sensors 140A and the base stations 162. In an aspect, to pre-process the event data, the analytics engine 120 may filter invalid and outlier data. Further, the analytics engine 120 may interpolate or impute missing data from available dataset of the events.

Furthermore, spatial and temporal features of the events emitted by the sensors 140 of the first toll gate 130A and the subset of toll gates 130B-130N and the events fired by the base stations 162 are determined. For example, the spatial features are determined to compute distances, clusters, or geospatial indexes and the temporal features are determined to calculate time differences, sequences, or periodic patterns. In this example, the spatial features may include geographic location area within the influence of a toll gate or a base station and the temporal features may include intersection of time intervals around the timestamp of a moment the sensors detected the vehicle and time intervals where a particular mobile device is registered at a base station.

Moreover, the analytics engine 120 may calculate a similarity score via the execution of the event-based matching technique. For example, the similarity score is calculated using a composite scoring mechanism that weighs spatial, temporal and event similarity. Furthermore, a subset of the events fired by the base stations for the mobile device corresponding to the vehicle is determined based on the similarity score. For example, a combined score may be 0.5*spatial score+0.3*temporal score+0.2*event score.

Also, the analytics engine 120 may determine, based on the correlation, identification information of a mobile device corresponding to the user of the vehicle (e.g., the driver of the vehicle or owner of the vehicle). For example, identification information of the mobile device may include one or more of International Mobile Equipment Identity (IMEI), International Mobile Subscriber Identity (IMSI), and Mobile Station International Subscriber Directory Number (MSISDN). In an example implementation, to determine the identification information of the mobile device, the analytics engine 120 may track handover information of the mobile device based on the correlation. Further, the analytics engine 120 may extract location data of the base stations 162, and timestamp information indicating mobile devices that are connected to corresponding ones of the base stations 162 at time of passage of the vehicle through the first toll gate 130A and at least the subset of the toll gates 130B-130N. In an example aspect, when multiple users are traveling in the vehicle, then the analytics engine 120 may identify the mobile device associated with the vehicle owner among the multiple users.

Moreover, the analytics engine 120 may transmit a notification to the user of the mobile device (e.g., the driver of the vehicle or the owner of the vehicle) regarding payment of the toll based at least on the identification information. For example, the notification may include transaction information associated with the vehicle, a link configured to facilitate payment of the toll for the vehicle.

To further illustrate the concepts described in FIG. 1, FIG. 2 depicts a block diagram 200 illustrating exemplary use cases for providing analytics and services in accordance with aspects of the present disclosure. In FIG. 2, the block diagram illustrates the toll gates 130A-130D, a plurality of base stations 162A-162D and a toll management system 110. The toll gates 130A-130D are spaced apart along a roadway 200 having one or more lanes of travel in different directions, shown by arrows 202, 204. It is noted that travel in each direction may be provided by multiple lanes of the roadway 200 and that vehicles may exit the roadway 200 via off-ramps 210. Although not shown, it is to be understood that the roadway 200 may also include on-ramps that enable drivers to enter the roadway 200 from one or more access roads.

As shown in FIG. 2, a vehicle travelling in the direction indicated by arrow 202 may exit the roadway 200 via an off-ramp 210 prior to reaching the toll gates 130B, 130C. If the vehicle exits the roadway 200 prior to reaching the toll gate 130C, no toll may be charged (e.g., if the toll gate 130C is a beginning of a toll portion of the roadway 200). But a toll may be charged for travelling between the toll gates 130B, 130C in the direction 202. It is noted that additional toll gates may be present along the roadway 200 and that such toll gates may be before, after, or in between the various toll gates 130A-130D shown in FIG. 2.

In an example use case, a vehicle is identified as travelling through the roadway 200 and passed the toll gates 130B and 130C. The sensors of the toll gates 130B, 130C may capture information from the vehicle as it passes by, such as to scan or read an RF tag attached to the vehicle, capture an image of a license plate of the vehicle, or both. In some instances, the vehicle may not have an RF tag, such as if the driver never registered with a tag toll service provider. In such instances, the toll service provider may need to rely on information of the license plate that can be read from the captured image data including image(s) of the vehicle to identify the registered user or vehicle owner for billing purposes. However, the images may not be clear or may not have captured appropriate license plate information. For example, the images may only capture a partial license plate or the license plate may have been removed or covered up to prevent identification of the vehicle. In such instances, the analytics and services provided by the toll management system 110 may enable identification of the user using the mobile communication network data. Further, the analytics and services provided by the toll management system 110 may also enable other functionality that is optimized as compared to existing data in the toll BO system 170, as described in more detail below.

As the sensor data is captured by the sensors 130A-130D of the roadway 200, the sensor data may be transmitted to a toll system (e.g., the toll BO system 170 of FIG. 1) where the data may be stored as the toll records in a database. The toll records may include the location of the toll gate that captured the data, the date and time the data is captured, the direction of travel (e.g., the direction 202 or 204 in FIG. 2) and the like. In an aspect, the data captured by the toll gates 130A-130D may be classified into different categories based on the available information. For example, a first classification may include toll records from vehicles associated with registered users. The first classification may include the toll records from vehicles which have the RF tag that is successfully scanned or read by one or more the toll gates 130A-130D, or records from vehicles with a license plate also successfully read by the one or more toll gates 130A-130D (using the captured image data) that are associated to a registered user. A second classification may include records with successfully read license plates from vehicles associated with unregistered users, such as vehicles identified using a license plate which is not associated to a known user of the toll system. A third classification may include records with unsuccessful read license plates associated with the image data having unreadable, missing, or incomplete license plate information and no transponder or RF tag that can be detected by the sensors 140A of the toll gate 130A.

Further, the various classifications of the toll record data may be provided to the toll management system 110 where video and other analytics may be applied to the data to predict an identity of the driver of the vehicle. The video analytics may be used to create groups of records based on similarity of features in the toll data, such as vehicle size, make, model, color, or other features (e.g., bumper stickers, damage to the vehicle, modifications to the vehicle, etc.). As a non-limiting example, the video analytics may be used to group records by vehicle type, such as to group all records associated with trucks together, all records associated with sport utility vehicles (SUVs) together, all records associated with 4 door sedans together, all records associated with 2 door sedans together, and the like. Additionally, the video analytics may be configured to further divide these groups into smaller groups, such as to group all trucks of a first type (e.g., Ford F-150 s) together, grouping other types of trucks together, and so on for each vehicle type. Similarly, each of these sub-groupings may then be further divided into sub-groups based on color or other features. It is noted that the video analytics may utilize computer-vision techniques or other types of image recognition and processing to form the groups of toll record data. In an aspect, the video analytics may be performed by the toll system prior to accessing the analytics and services provided by the toll management system 110. In an additional or alternative aspect, the video analytics may be applied by the toll management system 110. Furthermore, it is noted that the functionality described with reference to the toll management system 110 may be stand-alone and integrated with or part of the toll back-office system 170 of FIG. 1, provided via a cloud-based deployment, or other implementations depending on the particular system design.

Some of the toll records associated with missing or incomplete license plate or other identification data may be associated with or matched to registered users using the analytics provided by the toll management system 110. For example, the set of toll records may include records that indicate a vehicle having the same make, model, and color pass through the same toll gate(s) at the same or approximately same time on one or more days a week. To further refine the matching of the records, information may be obtained from a communications network provider, such as the mobile communication network data captured by the base stations 162A-162D. The information captured by the base stations 162A-162D may include identification information associated with mobile devices (IMEI, IMSI, MSISDN, and the like), location information associated with the location of the base station, date and time information (e.g., timestamp information indicating which mobile devices are connected to a base station at a particular time), handover information (e.g., information identifying a base station to which a mobile device is handed over), or other types of information. The identification information may indicate which mobile devices are connected to a particular base station near one of the toll gates 162A-162D and the handover information may be used to determine a direction of travel for the mobile device, which may indicate a corresponding direction of travel for the vehicle in which the mobile device is located. For example, if the handover information indicates the mobile device is handed from base station 162A to base station 162D, the direction of travel may be determined to be the direction 204. This may indicate the mobile device travelled past toll gate 130A towards toll gate 130D and the timestamp information may indicate a time the vehicle associated with the mobile device is near a particular toll gate.

Using the above-described information, the analytics engine 120 may identify correlations between particular toll records and the mobile communication network data that indicates a particular mobile device may be associated with a particular vehicle. In some examples, processing may allow to identify multiple coincident records of the same vehicle and the same mobile phone in the same location at the same exact moment (date and time) i.e., the coincidence of the toll records from the toll gates 130A-D and the mobile communication network data from the base stations 162A-D. For example, there may be a set of toll records associated with potentially the same vehicle (e.g., a group of records for a similar make, model, color, etc. vehicle) that passed through toll gates 130A-130D. Suppose that communications network data indicated a single mobile device is near the toll gates 130A-130D at times similar to a portion of the set of toll records. Such data may indicate that the mobile device is likely in the vehicle corresponding to the portion of the set of toll records.

In an aspect, one or more of the toll records included in the portion of the set of toll records may be associated with a registered user. In such instances, any records of the portion of the set of toll records having missing or incomplete vehicle data may then be associated with the registered user. As another example, suppose the portion of the toll records matching the mobile communication network data did not match any of the records associated with a registered user and the identity of the driver remains unknown (unregister user), even though some of the toll records may have been determined to correspond to the same vehicle. In such instances, the identity of the driver may be unknown but the mobile device associated with the vehicle is known. Thus, the analytics service device 110 may transmit a notification to the mobile device (e.g., based on information obtained from the communications network) to indicate the owner of the mobile device has one or more outstanding tolls to pay. As explained above, the notification may include information to facilitate payment of the toll charges. In an example, the image data depicting the vehicle passing through relevant toll gates may be included in the notification or accessible via a link included in the notification.

In some examples, the analytics provided by the toll management system 110 may also enable identification of vehicles associated with toll usage that may otherwise be unbillable (e.g. because the vehicle cannot be identified based on sensor information captured by a toll gate). The analytics engine 120 may enable to group toll records associated with the same vehicle in a manner that provides improved accuracy as compared to existing techniques. This toll records grouping capability allows toll records without license plate data to be correlated with others that have such information. This enables the completion of toll data lacking license plate information using records where it is available. If the license plate is not found in any of the grouped toll records, the toll management system can perform a second image review process. Thus, the second review would process images from various passages of the same vehicle simultaneously, increasing the likelihood of recognizing the license plate. For example, different parts of the license plate may be readable from different images. It is noted that grouping toll records may not always result in identification of the vehicle, but such records may at least be distinguished from other toll records, thereby preventing incorrect association of the records to other drivers. Thus, the analytics provided by the toll management system 110 may enable billing of toll transactions that may otherwise be unbillable using prior toll systems (e.g., because there is incomplete or missing license plate data preventing matching of a toll record to department of motor vehicle data records).

Additionally, the analytics provided by the toll management system 110 can potentially enable detection of different drivers for a same car. For example, it may be that certain individuals share a vehicle and use toll ways, such as the roadway 200. The different drivers may drive to different destinations with some regular frequency such that one driver passes a first set of toll gates when driving the vehicle and a second driver passes a second set of toll gates when driving. The analytics engine 120 may have capability to detect and signalize this type of profiles and based on machine learning mechanisms, improve the recognition of most relevant patterns and use it for the calculation of the confidence level that may attribute to the relation of vehicles to its driver's mobile device. In such instances, it may be determined that the first driver needs to be billed for toll charges corresponding to the first set of toll gates and the second driver for toll charges corresponding to the second set of toll gates. Such capabilities may be enabled through correlations between mobile devices of the first and second drivers being proximate the first set of toll gates or the second set of toll gates at times corresponding to timestamp data included in the toll records, thereby enabling billing for toll charges to be allocated on a per driver basis, rather than a per vehicle basis.

In an example implementation, the toll management system 110 may also enable analytics using data from other service providers and data sources. For example, the analytics provided by the toll management system 110 may be configured to utilize other types of data to correlate toll records to each other and/or drivers. For example, a data source may include financial transaction data provided by a financial service provider that indicates times and locations of transactions. For example, particular financial transactions (e.g., purchasing something at a store, an automated teller machine (ATM) transaction, and the like) within the vicinity of a toll gate and within a threshold period of time corresponding to the timestamp data can be included in the toll data. Such additional data points coupled with or used in the alternative to the communication data may enable higher probability predictions with respect to correlations with respect to different toll data records. Such additional data sources may also provide a mechanism for providing a higher degree of granularity when attempting to differentiate toll data that may otherwise seem identical, such as thousands of images of vehicles having the same make, model, and color captured by the toll gates.

Another example of an additional data source that may be incorporated into analytics of the toll management system 110 is third party car services, such as car rental companies. For example, rental car companies typically place a sticker or other marking on the vehicle to indicate it is part of a fleet of vehicles owned and maintained by the rental car company. The video analytics, together with fingerprint techniques, may be configured to detect such markings and associate toll records corresponding to vehicles bearing such feature to a rental car group. Subsequently, the data sources maintained by rental car companies may be used to retrieve information indicating a particular rental car potentially passed one or more toll gates. For example, if mobile device information is determined to provide a threshold degree of similarity to one or more toll records corresponding to a rental car company, the rental car data source(s) may be consulted to validate a vehicle matching the make, model, and color of vehicle is rented and potentially match other data captured by the rental car company with toll data or communication data, such as to verify a telephone number provided to the rental car company against data records of the toll system to determine whether the driver of the rental car is a registered toll driver. If so, charges may be billed to the driver's toll account or billed to the mobile device of the driver, rather than the rental car company.

It is to be understood that the exemplary types of data and data sources described above may be provided for purposes of illustration, rather than by way of limitation and that the toll management system 110 may utilize other types of data and data sources to provide analytics and services for supporting operation and maintenance of a toll system. It is noted that in some implementations, privacy preserving techniques may be utilized, such as to not provide telephone number information with the communications network data. In such instances, notifications may be transmitted to drivers via the mobile devices using a device identifier unique to the mobile device within the communication network, such as one of the identifiers described above with respect to the communication data or via a service provided by an operator of the communication network (e.g., provide a mobile device identifier and message content and the operator of the communication network transmits the notification to the driver's mobile device based on the mobile device identifier, where the notification includes with the message content).

Implementations of the present disclosure may be configured to provide analytics and services to supplement and support toll operations, responsible to manage tolling on the access and use of roadways. Utilizing sophisticated techniques, the present disclosure may analyze data gathered from both the toll gates and the base stations to correlate data registers for the same location at the same moment. Whenever the existing data allows for a confident conclusion of a relationship between a vehicle and a mobile device, this information can be used to support the toll collection operations. The analytics provided by the present disclosure may be utilized to enhance the toll system's capacity to identify vehicles, associate mobile devices with vehicles, and the like, and to enable new services to be provided in connection with toll operations. For example, the present disclosure may enable sending alerts or notifications to a driver's cell phone about outstanding toll road usage bills. If these bills are not paid, the driver may be subjected to extra costs. This approach can be more effective and reliable than relying on address information used by current systems that may be potentially out of date or inaccurate. The information of the mobile device can also be used to send information regarding discount policies and other relevant updates.

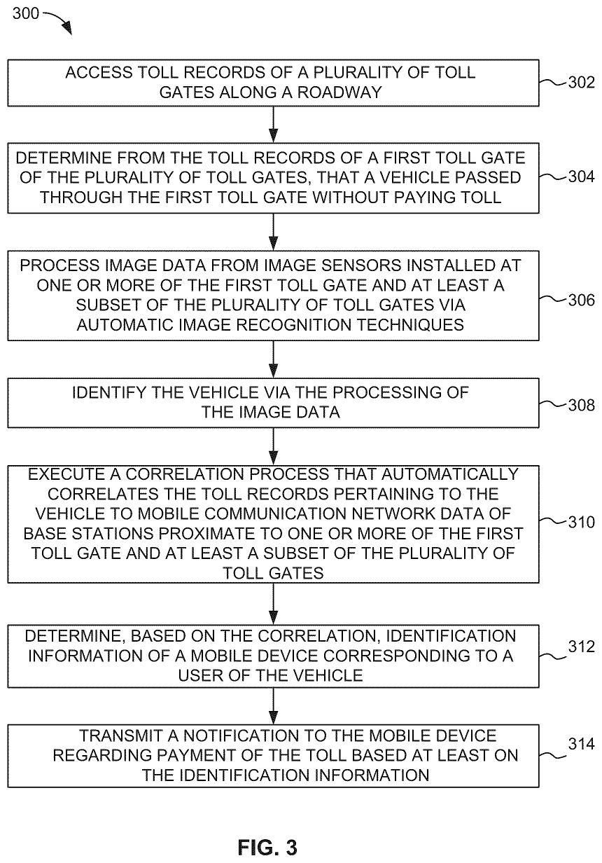

FIG. 3 is a flow diagram that presents a method 300 for providing toll analytics, in accordance with implementations of the present disclosure. At step 302, the method 300 includes accessing, by a processor, toll records of a plurality of toll gates along a roadway, the toll records include sensor data from Radio Frequency Identifier (RFID) sensors and image sensors installed at the plurality of toll gates. For example, the sensor data may include data associated with RFID tags from the RFID sensors and image data from the image sensors. In some examples, a particular data record of the toll records includes in addition to the sensor data, location data corresponding to a location of a toll gate generating the data record and time data corresponding to a time of capture of the data record by one or more of the sensors of the toll gate.

At step 304, the method 300 includes determining, by the processor, from the toll records of a first toll gate of the plurality of toll gates, that a vehicle passed through the first toll gate without paying toll. At step 306, the method 300 includes processing, by the processor, the image data of from the image sensors installed at one or more of the first toll gate and at least a subset of the plurality of toll gates via automatic image recognition techniques.

At step 308, the method 300 includes identifying, by the processor, the vehicle via the processing of the image data. In an example implementation, to identify the vehicle via the processing of the image data, the method 300 includes analyzing, by the processor, the images data from the image sensors installed at the first toll gate and at least the subset of the plurality of toll gates that include toll gates preceding and succeeding the first toll gate along the roadway. Further, the method 300 includes identifying, by the processor, passage of the vehicle through the first toll gate and the subset of toll gates from the image analysis.

In another implementation, to identify the vehicle from the image data, the method 300 includes identifying a license plate of the vehicle from the image data. Further, the method 300 includes determining that a license plate number of the vehicle is unidentifiable from the image data.

In some examples, to identify the vehicle from the image data, the method 300 includes classifying the toll records into three categories including a first category of toll records of registered vehicles with RFID tags that are successfully scanned or toll records of registered vehicles with license plates successfully identified from the image sensors, a second category of toll records of unregistered vehicles with license plates successfully identified from the image sensors of the first toll gate and a third category with toll records of unidentified vehicles including vehicles with unidentified license plates from the image data.

At step 310, the method 300 includes executing, by the processor, a correlation process that automatically correlates the toll records pertaining to the vehicle to mobile communication network data of base stations proximate to one or more of the first toll gate and at least the subset of the plurality of toll gates. For example, the mobile communication network data may include mobile device information generated by one or more of the base stations, the mobile device information may include timestamp data, mobile device identification data, and location data of the base stations.

In an example implementation, to execute the correlation process, the method 300 includes executing an event-based matching technique that includes temporal alignment, sequence similarity and event context matching of events emitted by the sensors of the first toll gate and at least the subset of the plurality of toll gates and events fired by the base stations proximate to the first toll gate and at least the subset of the plurality of toll gates.

In some examples, temporal overlap of the events associated with the vehicle is calculated from the first toll gate, at least the subset of the plurality of toll gates and the base stations based on a sequence of event timestamps.

In an example implementation, to obtain the sequence similarity, the method 300 includes aligning and comparing sequence of the events associated with the vehicle from the first toll gate, at least the subset of plurality of toll gates and the base stations. In this example implementation, dynamic time wrapping (DTW) is implemented. The sequence of events may be ordered and compared as time series data. Further, the ordered time series data is compared via a longest common subsequence (LCS) process. Furthermore, event contexts are matched via extracting and comparing temporal metadata from the first toll gate, at least the subset of the plurality of toll gates and the base stations.

Further, a similarity score is calculated via the execution of the event-based matching technique. For example, the similarity score is calculated using a composite scoring mechanism that weighs spatial, temporal and event similarity. Furthermore, a subset of the events fired by the base stations for the mobile device corresponding to the vehicle is determined based on the similarity score.

In some examples, to execute the correlation process, the method 300 includes pre-processing event data of events fired by the sensors of the first toll gate and at least the subset of the plurality of toll gates and events from the mobile network data fired by the base stations proximate to the first toll gate and at least the subset of the plurality of toll gates. Pre-processing the event data may include normalizing locations and mapping corresponding events fired at same location by the sensors and the base stations.

In an aspect, to pre-process the event data, the method 300 includes filtering invalid and outlier data. Further, the method 300 includes imputing missing data from available dataset of the events.

In some examples, to execute the correlation process, spatial and temporal features of the events emitted by the sensors of the first toll gate and the subset of toll gates and events fired by the base stations proximate to the first toll gate and at least the subset of the plurality of toll gates are extracted.

At step 312, the method 300 includes determining, by the processor, based on the correlation, identification information of a mobile device corresponding to a user of the vehicle. For example, identification information of the mobile device may include one or more of International Mobile Equipment Identity (IMEI), International Mobile Subscriber Identity (IMSI), and Mobile Station International Subscriber Directory Number (MSISDN). In an example implementation, to determine the identification information of the mobile device, the method 300 includes tracking, by the processor, handover information of the mobile device based on the correlation. Further, the method 300 includes extracting, by the processor, location data of the base stations, and timestamp information indicating mobile devices that are connected to corresponding ones of the base stations at time of passage of the vehicle through the first toll gate and at least the subset of the plurality of toll gates.

At step 314, the method 300 includes transmitting, by the processor, a notification to the mobile device regarding payment of the toll based at least on the identification information. For example, the notification may include transaction information associated with the vehicle, a link configured to facilitate payment of the toll for the vehicle.

Implementations of the present disclosure provide technical solutions to multiple technical problems that arise in the context of toll collection systems. Implementations of the present disclosure provide a special applicability for All Electronic Tolling (AET) systems, that supports toll collection based on vehicle image capture. The present disclosure may support recovery of revenue leakage related to transactions that a road system fails to properly detect (currently treated as write-off transactions). The prosed disclosure solution may provide access to a mobile phone contact of unknown users (not preregistered customers), which may always exist even though incentives developed at different levels regarding increment of having proactively registered users.

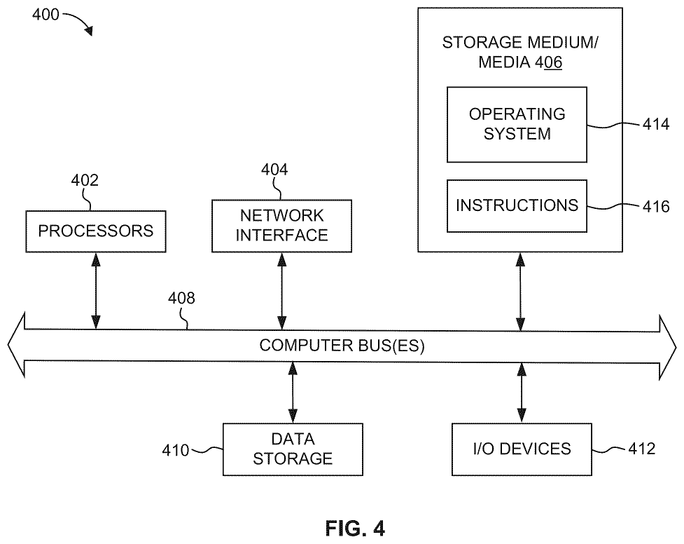

FIG. 4 depicts a computer system 400 (i.e., the toll management system 110) that may be used to implement the method 300. More particularly, computing machines such as desktops, laptops, smartphones, tablets, and wearables which may be used to for summarization of a real-time event and prediction of one or more actions in the summarized real-time event. The computer system 400 may include additional components not shown and that some of the process components described may be removed and/or modified. In another example, the computer system 400 may be deployed on external-cloud platforms such as cloud, internal corporate cloud computing clusters, organizational computing resources, and/or the like.

The computer system 400 includes processor(s) 402, such as a central processing unit, ASIC or another type of processing circuit, input/output devices 404, such as a display, mouse keyboard, and/or the like, a network interface 406, such as a Local Area Network (LAN), a wireless 802.11x LAN, a 3G or 4G mobile WAN or a WiMax WAN, and a computer-readable medium 408. Each of these components may be operatively coupled to a bus 410. The computer-readable medium 408 may be any suitable medium that participates in providing instructions to the processor(s) 402 for execution. For example, the computer-readable medium 408 may be non-transitory or non-volatile medium, such as a magnetic disk or solid-state non-volatile memory or volatile medium such as RAM. The instructions or modules stored on the computer-readable medium 408 may include machine-readable instructions 412 executed by the processor(s) 402 that cause the processor(s) 402 to perform the method 300.

The computing system 400 may be implemented as software stored on a non-transitory processor-readable medium and executed by the processor(s) 402. For example, the computer-readable medium 408 may store an operating system 414, such as MAC OS, MS WINDOWS, UNIX, or LINUX, and code, for the computing system 400. The operating system 414 may be multi-user, multiprocessing, multitasking, multithreading, real-time, and the like. For example, during runtime, the operating system 414 is running and the code for the computing system 400 is executed by the processor(s) 402.

The computer system 400 may include a data storage 416, which may include non-volatile data storage. The data storage 416 stores any data used or generated by the computer system 400.

The network interface 406 connects the computer system 400 to internal systems for example, via a LAN. Also, the network interface 406 may connect the computer system 400 to the Internet. For example, the computer system 400 may connect to web browsers and other external applications and systems via the network interface 406.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 402 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
at least one hardware processor; and
at least one non-transitory processor-readable medium storing instructions to be executed by the at least one hardware processor to:
access toll records of a plurality of toll gates along a roadway,
the toll records include sensor data from Radio Frequency Identifier (RFID) sensors and image sensors installed at the plurality of toll gates, wherein the sensor data comprises data associated with RFID tags from the RFID sensors and image data from the image sensors;
determine from the toll records of a first toll gate of the plurality of toll gates, that a vehicle passed through the first toll gate without paying toll;
process the image data from the image sensors installed at one or more of the first toll gate and at least a subset of the plurality of toll gates via automatic image recognition techniques;
identify the vehicle via the processing of the image data;
automatically execute a correlation process that correlates the toll records pertaining to the vehicle to mobile communication network data of base stations proximate to one or more of the first toll gate and at least the subset of the plurality of toll gates;
determine, based on the correlation, identification information of a mobile device corresponding to a user of the vehicle; and
transmit a notification to the mobile device regarding payment of the toll based at least on the identification information.

2. The system of claim 1, wherein the instructions to identify the vehicle from the image data further cause the at least one hardware processor to:
classify the toll records into three categories including a first category of toll records of registered vehicles with RFID tags that are successfully scanned or toll records of registered vehicles with license plates successfully identified from the image sensors, a second category of toll records of unregistered vehicles with license plates successfully identified from the image sensors of the first toll gate and a third category with toll records of unidentified vehicles including vehicles with unidentified license plates from the image data.

3. The system of claim 2, wherein the instructions to identify the vehicle from the image data further cause the at least one hardware processor to:
identify the vehicle from the image data captured by the image sensors of the first toll gate and at least the subset of the plurality of toll gates that include a preceding toll gate and a succeeding toll gate of the first toll gate.

4. The system of claim 1, wherein the instructions to identify the vehicle from the image data further cause the at least one hardware processor to:
identify a license plate of the vehicle from the image data; and
determine that a license plate number of the vehicle is unidentifiable from the image data.

5. The system of claim 1, wherein the instructions to execute the correlation process automatically correlating the toll records pertaining to the vehicle to the mobile communication network data further cause the at least one hardware processor to:
execute an event-based matching technique that comprises temporal alignment, sequence similarity and event context matching of events emitted by the sensors of the first toll gate and at least the subset of the plurality of toll gates and events fired by the base stations proximate to the first toll gate and at least the subset of the plurality of toll gates;
calculate a similarity score via the execution of the event-based matching technique; and
identify a subset of the events fired by the base stations for the mobile device corresponding to the vehicle based on the similarity score.

6. The system of claim 5, wherein the instructions to execute the temporal alignment further cause the at least one hardware processor to:
calculate temporal overlap of the events associated with the vehicle from the first toll gate, at least the subset of the plurality of toll gates and the base stations based on a sequence of event timestamps.

7. The system of claim 6, wherein the instructions to obtain the sequence similarity further cause the at least one hardware processor to:
align and compare sequence of the events associated with the vehicle from the first toll gate, at least the subset of plurality of toll gates and the base stations.

8. The system of claim 7, wherein the instructions to align and compare the sequence of events associated with the vehicle further cause the at least one hardware processor to:
implement dynamic time wrapping (DTW), wherein the sequence of events are ordered and compared as time series data;
compare the ordered time series data via a longest common subsequence (LCS) process; and
match event contexts via extracting and comparing temporal metadata from the first toll gate, at least the subset of the plurality of toll gates and the base stations.

9. The system of claim 5, wherein the instructions to execute the correlation process of automatically correlating the toll records pertaining to the vehicle to the mobile communication network data further cause the at least one hardware processor to:
pre-process event data of events fired by the sensors of the first toll gate and at least the subset of the plurality of toll gates and events from the mobile network data fired by the base stations proximate to the first toll gate and at least the subset of the plurality of toll gates,
wherein pre-processing the event data includes normalizing locations and mapping corresponding events fired at same location by the sensors and the base stations.

10. The system of claim 9, wherein the instructions to pre-process the event data further cause the at least one hardware processor to:
filter invalid and outlier data; and
impute missing data from available dataset of the events.

11. The system of claim 5, wherein the instructions to execute the correlation process further cause the at least one hardware processor to:
extract spatial and temporal features of the events emitted by the sensors of the first toll gate and the subset of toll gates and events fired by the base stations proximate to the first toll gate and at least the subset of the plurality of toll gates.

12. The system of claim 11, wherein the instructions to calculate the similarity score further cause the at least one hardware processor to:
calculate the similarity score using a composite scoring mechanism that weighs spatial, temporal and event similarity.

13. A processor-executable method comprising:
accessing, by a processor, toll records of a plurality of toll gates along a roadway,
the toll records include sensor data from Radio Frequency Identifier (RFID) sensors and image sensors installed at the plurality of toll gates, wherein the sensor data comprises data associated with RFID tags from the RFID sensors and image data from the image sensors;
determining, by the processor, from the toll records of a first toll gate of the plurality of toll gates, that a vehicle passed through the first toll gate without paying toll;
processing, by the processor, the image data from the image sensors installed at one or more of the first toll gate and at least a subset of the plurality of toll gates via automatic image recognition techniques;
identifying, by the processor, the vehicle via the processing of the image data;
executing, by the processor, a correlation process that automatically correlates the toll records pertaining to the vehicle to mobile communication network data of base stations proximate to one or more of the first toll gate and at least the subset of the plurality of toll gates;
determining, by the processor, based on the correlation, identification information of a mobile device corresponding to a user of the vehicle; and
transmitting, by the processor, a notification to the mobile device regarding payment of the toll based at least on the identification information.

14. The processor executable method of claim 13, wherein identifying the vehicle via the processing of the image data further comprises:
analyzing, by the processor, the image data from the image sensors installed at the first toll gate and at least the subset of the plurality of toll gates that include toll gates preceding and succeeding the first toll gate along the roadway; and
identifying, by the processor, passage of the vehicle through the first toll gate and the subset of toll gates from the image analysis.

15. The processor executable method of claim 13, wherein determining the identification information of the mobile device further comprises:
tracking, by the processor, handover information of the mobile device based on the correlation.

16. The processor executable method of claim 13, wherein determining the identification information of the mobile device further comprises:
extracting, by the processor, location data of the base stations, and timestamp information indicating mobile devices that are connected to corresponding ones of the base stations at time of passage of the vehicle through the first toll gate and at least the subset of the plurality of toll gates.

17. The processor executable method of claim 13, wherein identification information of the mobile device further comprises one or more of International Mobile Equipment Identity (IMEI), International Mobile Subscriber Identity (IMSI), and Mobile Station International Subscriber Directory Number (MSISDN).

18. A non-transitory processor-readable storage medium comprising machine-readable instructions that cause a processor to:
access toll records of a plurality of toll gates along a roadway,
the toll records include sensor data from Radio Frequency Identifier (RFID) sensors and image sensors installed at the plurality of toll gates, wherein the sensor data comprises data associated with RFID tags from the RFID sensors and image data from the image sensors;
determine from the toll records of a first toll gate of the plurality of toll gates, that a vehicle passed through the first toll gate without paying toll;
process the image data from the image sensors installed at one or more of the first toll gate and at least a subset of the plurality of toll gates via automatic image recognition techniques;
identify the vehicle via the processing of the image data;
automatically execute a correlation process that correlates the toll records pertaining to the vehicle to mobile communication network data of base stations proximate to one or more of the first toll gate and at least the subset of the plurality of toll gates;
determine, based on the correlation, identification information of a mobile device corresponding to a user of the vehicle; and
transmit a notification to the mobile device regarding payment of the toll based at least on the identification information.

19. The non-transitory processor-readable storage medium of claim 18, wherein a particular data record of the toll records comprises in addition to the sensor data, location data corresponding to a location of a toll gate generating the data record and time data corresponding to a time of capture of the data record by one or more of the sensors of the toll gate, and wherein the mobile communication network data comprises mobile device information generated by one or more of the base stations, the mobile device information comprising timestamp data, mobile device identification data, and location data of the base stations.

20. The non-transitory processor-readable storage medium of claim 18, wherein the notification comprises transaction information associated with the vehicle, a link configured to facilitate payment of the toll for the vehicle.
